(19) United States
(12) Patent Application Publication
(10) Pub. No.: US 2012/0236195 A1
(43) Pub. Date: Sep. 20, 2012

(54) ELECTRONIC DEVICE

(75) Inventor: Yi-Chung Chang, New Taipei City (TW)

(73) Assignee: HANNSTAR DISPLAY CORPORATION, New Taipei City (TW)

(21) Appl. No.: 13/371,485

(22) Filed: Feb. 13, 2012

(30) Foreign Application Priority Data
Mar. 16, 2011 (TW) 100108945

(51) Int. Cl. H04N 5/225

(52) U.S. Cl. 348/333.06; 348/373; 348/E05.026

(57) ABSTRACT

An electronic device includes a body, a first pivot element, a second pivot element, and an image capturing module. The first pivot element is pivoted to the body and used for rotating along a first axis as a rotating axis. The second pivot element is pivoted to the first pivot element and used for rotating along a second axis as a rotating axis. The first axis is substantially perpendicular to the second axis. The image capturing module is configured in the second pivot element and electrically connected to the body for capturing an image outside the second pivot element.

### CROSS-REFERENCE TO RELATED APPLICATION

This application claims the priority benefit of Taiwan application serial no. 100108945, filed Mar. 16, 2011. The entirety of the above-mentioned patent application is hereby incorporated by reference herein and made a part of this specification.

### BACKGROUND OF THE INVENTION

1. Field of the Invention

The invention relates to an electronic device. More particularly, the invention relates to an electronic device that has an image capturing module characterized by biaxial rotation.

2. Description of Related Art

With development of science, technology, and network, it is necessary for an electronic device to be equipped with an image capturing module, such that a user can interact with a remote user through the internet. Besides, the image capturing module can be applied to record personal audio and video clips.

FIG. 1 is a schematic three-dimensional view illustrating a conventional notebook computer. With reference to FIG. 1, a webcam 110 of the notebook computer 100 is designed to face a user, such that the webcam 110 can easily capture images of the user. When images of a speaker other than the user are required to be captured by the webcam 110 in a conference, a speech, or the like, the notebook computer 100 need be turned around to face the speaker because the location of the computer 100 while the images of the speaker are being captured.

### SUMMARY OF THE INVENTION

The invention is directed to an electronic device which can facilitate the use of a webcam.

In an embodiment of the invention, an electronic device that includes a body, a first pivot element, a second pivot element, and an image capturing module is provided. The first pivot element is pivoted to the body and used for rotating along a first axis as a rotating axis. The second pivot element is pivoted to the first pivot element and used for rotating along a second axis as the rotating axis. The first axis is substantially perpendicular to the second axis. The image capturing module is configured in the second pivot element and electrically connected to the body for capturing an image outside the second pivot element.

According to an embodiment of the invention, the electronic device further includes a microphone configured in the second pivot element and electrically connected to the body for capturing sound.

According to an embodiment of the invention, a maximum rotation angle of the first pivot element is smaller than 360 degrees.

According to an embodiment of the invention, a maximum rotation angle of the second pivot element is substantially equal to 180 degrees.

According to an embodiment of the invention, the body has a display unit and an accommodation opening, and the image capturing module and the display unit face toward the same direction when the first pivot element and the second pivot element are substantially placed in the accommodation opening.

According to an embodiment of the invention, the body includes a display portion and a host. The display portion is pivoted to the host. The first pivot element is pivoted to the display portion.

Based on the above, the image capturing module described in the embodiments of the invention is connected to the body via two pivot elements. Thereby, the image capturing module can rotate relatively to the body in a biaxial manner, which facilitates the use of the image capturing module.

Other features and advantages of the invention will be further understood from the further technological features disclosed by the embodiments of the invention wherein there are shown and described embodiments of this invention, simply by way of illustration of best modes to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic three-dimensional view illustrating a conventional notebook computer.

FIG. 2A to FIG. 2D respectively illustrate an electronic device in four different states according to an embodiment of the invention.

FIG. 3 is a schematic cross-sectional view illustrating that a pivot portion of the first and second elements depicted in FIG. 2A is perpendicular to a Y-axis.

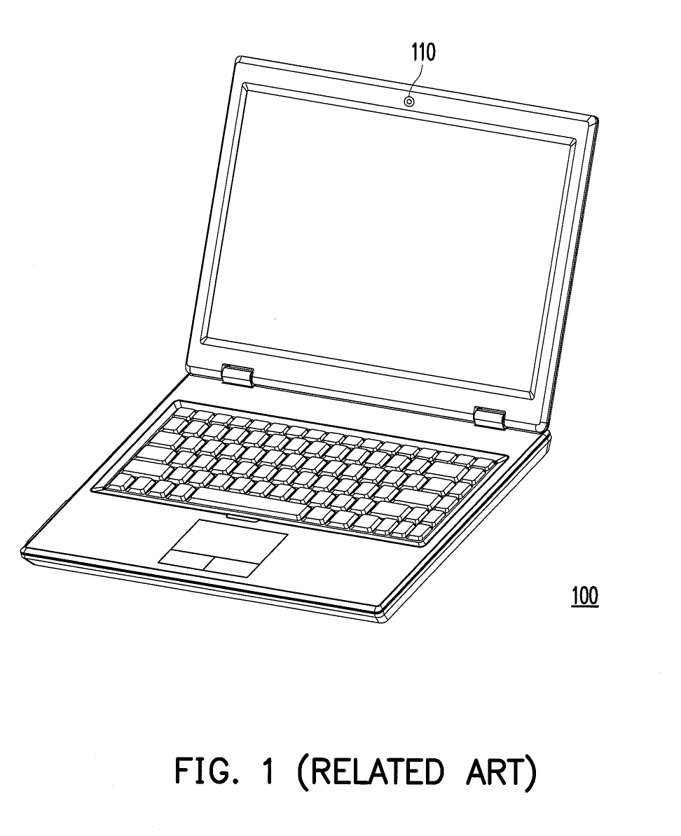

### DESCRIPTION OF EMBODIMENTS

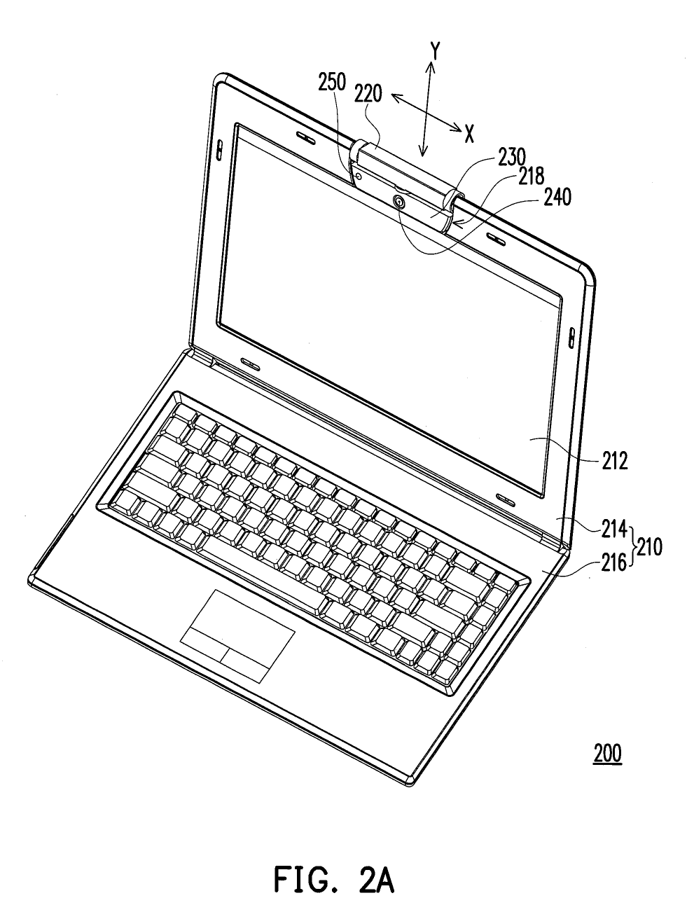

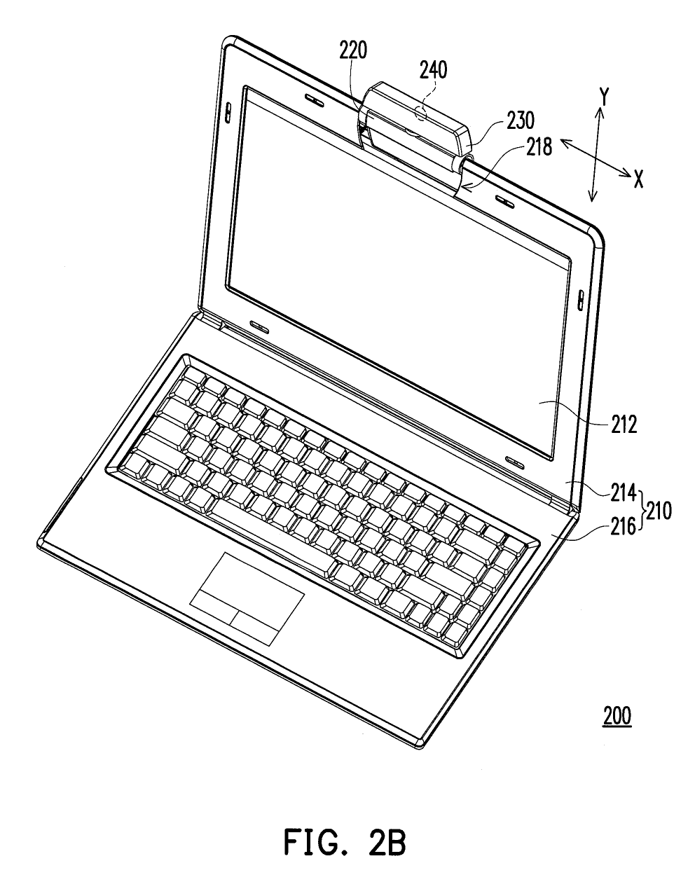

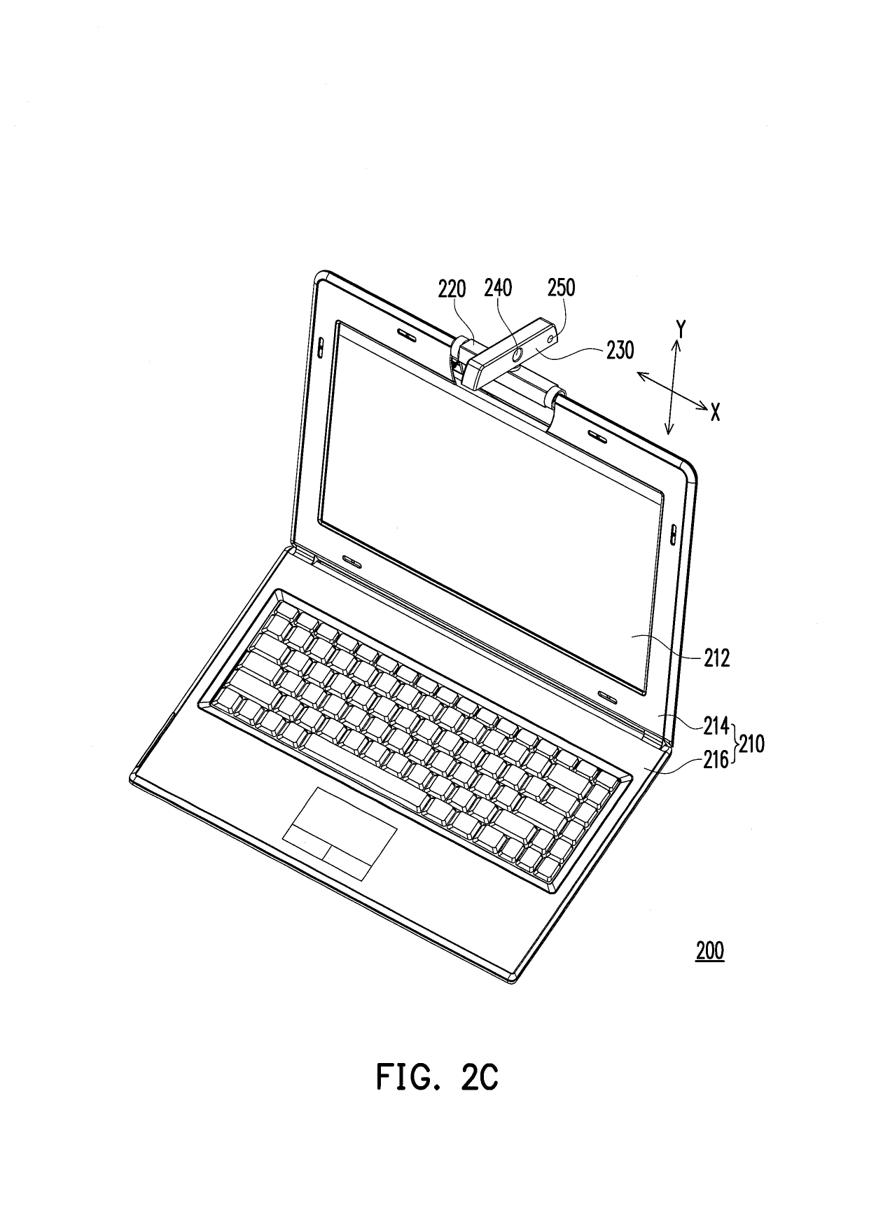

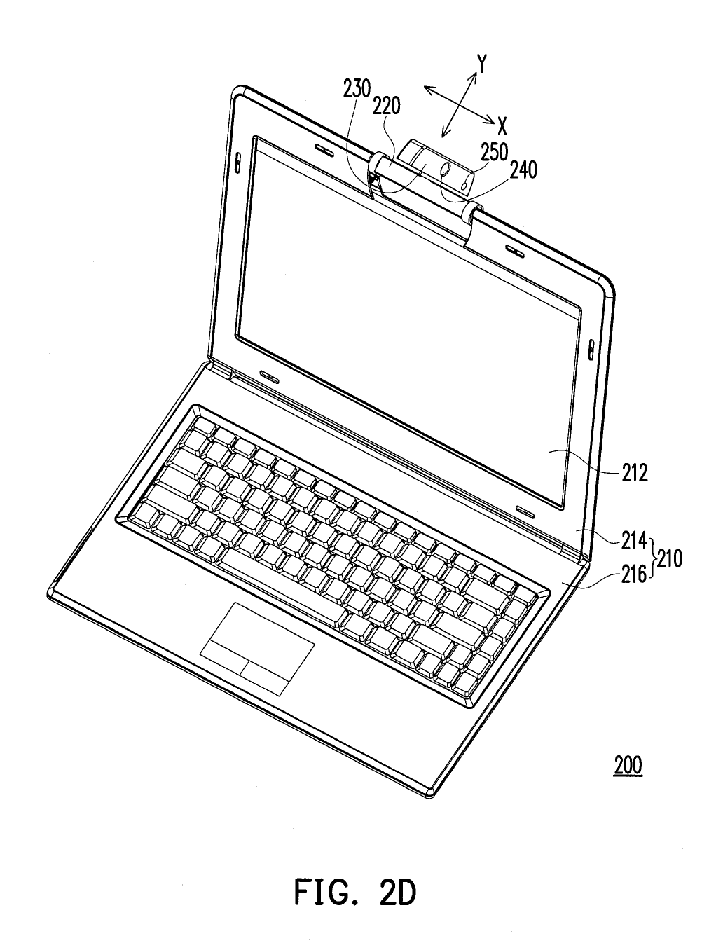

FIG. 2A to FIG. 2D respectively illustrate an electronic device in four different states according to an embodiment of the invention. With reference to FIG. 2A, the electronic device 200 of this embodiment includes a body 210, a first pivot element 220, a second pivot element 230, and an image capturing module 240. The first pivot element 220 is pivoted to the body 210 and used for rotating along a first axis X as a rotating axis. The second pivot element 230 is pivoted to the first pivot element 220 and used for rotating along a second axis Y as a rotating axis. The first axis X is substantially perpendicular to the second axis Y. Note that the second axis Y is set relatively to the first pivot element 220. Accordingly, when the first pivot element 220 rotates, the second axis Y also rotates together with the rotating first pivot element 220. It should be mentioned the first axis X remains perpendicular to the second axis Y. The image capturing module 240 is configured in the second pivot element 230 and electrically connected to the body 210 for capturing an image outside the second pivot element 230. That is to say, a user can capture images by directing the body 210 to control the image capturing module 240. Although the image capturing module 240 is configured in the second pivot element 230, the second pivot element 230 can have an opening or a transparent region corresponding to the image capturing module 240, such that the image capturing module 240 is able to capture the image outside the second pivot element 230.

When the electronic device 200 is in the state as shown in FIG. 2A, the image capturing module 240 and a display unit 212 of the body 210 face toward the same direction, i.e., face the user of the electronic device 200, so as to easily capture the images of the user.

When the electronic device 200 is in the state as shown in FIG. 2B, the first pivot element 220 rotates 180 degrees with respect to the first pivot element 220 shown in FIG. 2A, while the second pivot element 230 does not rotate relatively to the first pivot element 220. Hence, the image capturing module 240 can capture images of surroundings, human beings, and/or objects opposite to the user. Meanwhile, the user can still operate the electronic device 200 with ease.

When the electronic device 200 is in the state as shown in FIG. 2C, the first pivot element 220 does not rotate with respect to the first pivot element 220 shown in FIG. 2B, while the second pivot element 230 rotates 90 degrees relatively to the first pivot element 220. Hence, the image capturing module 240 can capture images of surroundings, human beings, and/or objects located at the side of the user. Meanwhile, the user can still operate the electronic device 200 with ease.

In FIG. 2D, the first and second pivot elements 220 and 230 both rotate with respect to the first and second pivot elements 220 and 230 shown in FIG. 2C. Since the first and second pivot elements 220 and 230 allow the biaxial rotation, the image capturing module 240 configured in the second pivot element 230 can capture images in different directions with respect to the body 210. Besides, it is not necessary to move or rotate the body 210 when the rotation angle of the image capturing module 240 varies, and the user can constantly operate the electronic device 200 with ease. Accordingly, the use of the electronic device 200 is significantly facilitated according to this embodiment.

The electronic device 200 of this embodiment can further include a microphone 250 that is configured in the second pivot element 230 and electrically connected to the body 210 for capturing sound. Similar to the image capturing module 240, the microphone 250 is configured in the second pivot element 230. Therefore, the microphone 250 and the image capturing module 240 have the synchronized motion and thereby simultaneously capture the sound and the image, respectively. Consequently, the microphone 250 can directly face the direction where the source of the to-be-captured sound is located for optimal audio reception.

The body 210 of this embodiment has an accommodation opening 218. When the first and second pivot elements 220 and 230 are substantially placed in the accommodation opening 218, the image capturing module 240 and the display unit 212 face the same direction, as indicated in FIG. 2A. The state shown in FIG. 2A is the most common state. Therefore, from an aesthetic perspective, the first and second pivot elements 220 and 230 can be completely placed in the accommodation opening 218 when the electronic device 200 is in the state as shown in FIG. 2A. When necessary, the user rotates the first pivot element 220 and/or the second pivot element 230, such that the second pivot element 230 is moved away from the accommodation opening 218 and is in the state as respectively shown in FIG. 2B to FIG. 2D.

In this embodiment, the electronic device 200 is a notebook computer, for instance. That is to say, the body 210 of the electronic device 200 includes a display portion 214 and a host 216. The display portion 214 is pivoted to the host 216 and has a display unit 212. The first pivot element 220 is pivoted to the display portion 214. According to other embodiments of the invention, the electronic device 200 can also be a tablet PC, a mobile phone, or any other electronic device.

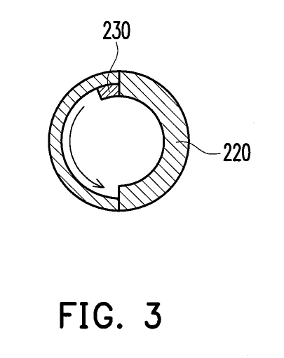

In general, the image capturing module 240 can include connection wires, a flexible circuit board, a capacitance coupling device (CCD), and a lens. In this embodiment, the maximum rotation angle of the first pivot element 220 is 360 degrees, which should not be construed as a limitation to the invention. As a matter of fact, the maximum rotation angle of the first pivot element 220 can be close to but smaller than 360 degrees, so as to ensure that the second pivot element 230 does not interfere with the body 210. In the meantime, the connection between the connection wires and the flexible circuit board of the image capturing module 240 is not negatively affected by the excessive rotation. Similarly, in this embodiment, the maximum rotation angle of the second pivot element 230 is 180 degrees, which should not be construed as a limitation to the invention. FIG. 3 is a schematic cross-sectional view illustrating that a pivot portion of the first and second elements depicted in FIG. 2A is perpendicular to a Y-axis. For instance, as shown in FIG. 3, the simple structural design of the pivot portion of the first and second pivot elements 220 and 230 can restrict the maximum rotation angle of the second pivot element 230 to be 180 degrees.

In light of the foregoing, the image capturing module of the electronic device is connected to the body via two pivot elements according to the embodiments of the invention. Thereby, the image capturing module can rotate relatively to the body in a biaxial manner. The fixed body of the electronic device ensures the user to operate the electronic device with ease. Moreover, the image capturing module can capture images at different locations, which significantly facilitates the use of the electronic device.

Although the invention has been described with reference to the above embodiments, it will be apparent to one of the ordinary skill in the art that modifications to the described embodiments may be made without departing from the spirit of the invention. Accordingly, the scope of the invention will be defined by the attached claims rather than by the above detailed descriptions.

What is claimed is:

1. An electronic device comprising:
a body;
a first pivot element for rotating along a first axis as a rotating axis, the first pivot element being pivoted to the body;
a second pivot element for rotating along a second axis as a rotating axis, the second pivot element being pivoted to the first pivot element, wherein the first axis is substantially perpendicular to the second axis; and
an image capturing module configured in the second pivot element and electrically connected to the body for capturing an image outside the second pivot element.

2. The electronic device as recited in claim 1, further comprising a microphone configured in the second pivot element and electrically connected to the body for capturing sound.

3. The electronic device as recited in claim 1, wherein a maximum rotation angle of the first pivot element is smaller than 360 degrees.

4. The electronic device as recited in claim 1, wherein a maximum rotation angle of the second pivot element is substantially equal to 180 degrees.

5. The electronic device as recited in claim 1, wherein the body has a display unit and an accommodation opening, and the image capturing module and the display unit face toward a same direction when the first pivot element and the second pivot element are substantially placed in the accommodation opening.

6. The electronic device as recited in claim 1, wherein the body comprises a display portion and a host, the display portion is pivoted to the host, and the first pivot element is pivoted to the display portion.
